(19) United States
(12) Patent Application Publication
(10) Pub. No.: US 2015/0047682 A1
(43) Pub. Date: Feb. 19, 2015

(54) DEWAXING DEVICE AND METHOD OF RECYCLING CHEMICAL SOLVENT USED BY THE DEWAXING DEVICE

(71) Applicant: Cheng Uei Precision Industry Co., Ltd., New Taipei City (TW)

(72) Inventors: CHENG YU CHOU, New Taipei City (TW); CHI-JU SU, New Taipei City (TW); CHENG AN CHIANG, New Taipei City (TW); CHIH WEI CHENG, New Taipei City (TW)

(73) Assignee: Cheng Uei Precision Industry Co., Ltd., New Taipei City (TW)

(21) Appl. No.: 13/970,593

(22) Filed: Aug. 19, 2013

(51) Int. Cl. B08B 3/08

(52) U.S. Cl. CPC B08B 3/08
USPC 134/108; 570/262

(57) ABSTRACT

A dewaxing device and a method of recycling chemical solvent used by the dewaxing device are shown. The dewaxing device includes a dewaxing system and a recycling system. The dewaxing system includes a rinsing device and a storage device connected with the rinsing device via a circulation pipe. The recycling system includes a cooling equipment connected with the storage device for cooling mixed solution with wax from the storage device to precipitate wax out of the mixed solution, a filter equipment connected with the cooling equipment for filtering out the precipitated wax, and a recycling trough connected between the filter equipment and the storage device for containing the filtered solution passing through the filter equipment and further conveying the filtered solution back into the storage device to be reused.

### BACKGROUND OF THE INVENTION

1. Field of the Invention

The present invention relates to a dewaxing device, and more particularly to a chemical dewaxing device and a method of recycling chemical solvent used by the dewaxing device.

2. The Related Art

Metal injection molding is a metalworking process where finely-powdered metal is mixed with a measured amount of binder and wetting agent to comprise a feedstock capable of being handled by plastic processing equipment through a process known as injection mold forming. Subsequent conditioning operations are performed on the molded shape, where the wetting agent and the binder are removed from a green part of product and metal particles are coalesced into the desired state for the metal alloy. In detail, the wetting agent is removed by chemical solvent or sintering furnace to form pores in dewaxing process of the metal injection molding, and the binder is thermal-cracked into binder gas to go out through the pores in sintering process of the metal injection molding.

In order to effectively achieve the dewaxing process, it is a common way that the wetting agent is removed by the chemical solvent. In detail, the wetting agent can be removed by repeatedly rinsing the green part of product with the chemical solvent or keeping soaking the green part of product in the chemical solvent so as to dissolve the wetting agent out of the green part of product, wherein the chemical solvent can be n-hexane, n-butane, bromopropane, cleaning naphtha and so on. Because of increased awareness of environmental protection, the chemical solvent has gradually tended to use the bromopropane solvent which has recyclable characteristics.

In the dewaxing process, when the bromopropane solvent reaches saturation state, a recycling process is done for recycling the bromopropane solvent. In detail, in the recycling process, the saturated solution needs to be heated to boiling to separate into bromopropane steam and high concentration of non-volatile liquid waste wax. Then utilize a condensing unit to condense the bromopropane steam into liquid so as to obtain pure bromopropane solvent again. The high concentration of non-volatile liquid waste wax is removed out. However, in the recycling process, the saturated solution needs to be heated to boiling and then be cooled so that will have a strong impact on use life of the bromopropane solvent. So, a dewaxing device having an improved recycling system for doing the recycling process to recycle the chemical solvent is required.

### SUMMARY OF THE INVENTION

An object of the present invention is to provide a dewaxing device of utilizing chemical solvent to dewax a green part of product formed by metal injection molding. The dewaxing device includes a dewaxing system for dewaxing the green part of product and a recycling system. The dewaxing system includes a rinsing device where the green part of product is placed and a storage device where the chemical solvent is stored. The storage device is connected with the rinsing device via a circulation pipe for utilizing the chemical solvent to soak and rinse the green part of product. The recycling system includes a cooling equipment which is connected with the storage device of the dewaxing system for cooling mixed solution with wax from the storage device to precipitate wax out of the mixed solution, a filter equipment which is connected with the cooling equipment for filtering out the precipitated wax, and a recycling trough which is connected between the filter equipment and the storage device for containing the filtered solution passing through the filter equipment and further conveying the filtered solution back into the storage device to be reused.

Another object of the present invention is to provide a method of recycling the chemical solvent used by the dewaxing device. The method includes the following steps:
(1) convey the mixed solution with wax from the storage device of the dewaxing system to pass through the cooling equipment of the recycling system for cooling the mixed solution with wax to a preset temperature, solidity or colloid wax is precipitated out of the cooled solution at the preset temperature;
(2) utilize the filter equipment to filter out the precipitated solidity or colloid wax; and
(3) utilize the recycling trough to contain the filtered solution passing through the filter equipment and further convey the filtered solution back into the storage device of the dewaxing system to be reused.

As described above, according to the technical principle that the soluble wax quantity of the chemical solvent does change with temperature, the recycling system of the dewaxing device in this invention utilizes the cooperation design of the cooling equipment and the filter equipment to effectively remove wax in the mixed solution and finally obtain almost pure chemical solvent in the recycling process.

### BRIEF DESCRIPTION OF THE DRAWINGS

The present invention will be apparent to those skilled in the art by reading the following description, with reference to the attached drawings, in which:

FIG. 1 is a view of a dewaxing device according to an embodiment of the present invention; and

FIG. 2 is a view showing the soluble wax quantity of bromopropane solvent does change with temperature.

### DETAILED DESCRIPTION OF THE PREFERRED EMBODIMENT

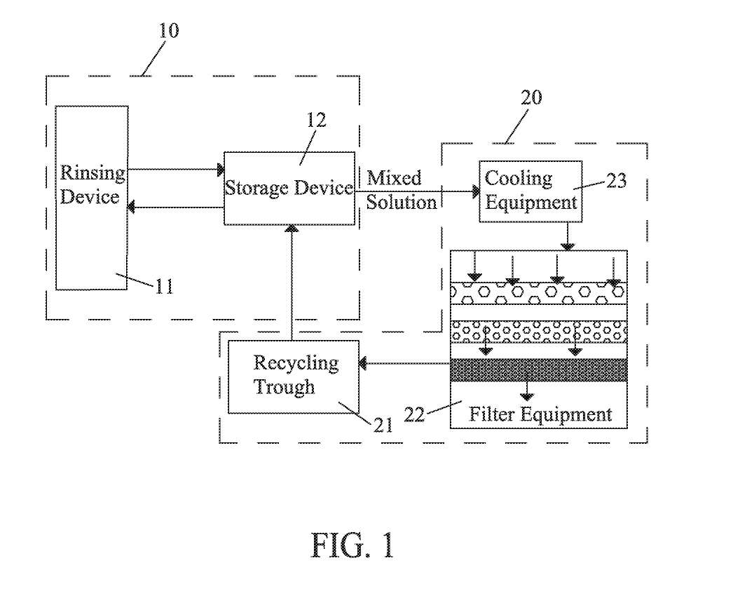

With reference to FIG. 1, a dewaxing device according to an embodiment of the present invention is used in dewaxing process of metal injection molding for removing wax of a green part of product by virtue of utilizing chemical solvent to soak and repeatedly rinse the green part of product. In this embodiment, the chemical solvent is bromopropane solvent. The dewaxing device includes a dewaxing system 10 and a recycling system 20.

The dewaxing system 10 is used to dewax the green part of product. In detail, the dewaxing system 10 includes a rinsing device 11 where the green part of product is placed for being soaked and rinsed with the bromopropane solvent, and a storage device 12 where the bromopropane solvent is stored. The storage device 12 is connected with the rinsing device 11 via a circulation pipe so that the bromopropane solvent can circulation flow through the rinsing device 11 to repeatedly rinse the green part of product so as to dissolve the wax out of the green part of product as thorough as possible. After the dewaxing process is done by the dewaxing system 10, the bromopropane solvent in the storage device 12 becomes a mixed solution with wax.

The recycling system 20 is connected with the storage device 12 of the dewaxing system 10 for recycling the chemical solvent, namely removing wax out of the mixed solution as much as possible. In detail, the recycling system 20 includes a cooling equipment 23 connected with the storage device 12 for cooling the mixed solution with wax to precipitate wax out of the mixed solution, a filter equipment 22 connected with the cooling equipment 23 for filtering out the precipitated wax, and a recycling trough 21 connected between the filter equipment 22 and the storage device 12 for containing the filtered solution which passes through the filter equipment 22 and further conveying the filtered solution back into the storage device 12 to be reused. In this embodiment, the filter equipment 22 is equipped with a plurality of filters therein and the cooling equipment 23 is a refrigerator.

Referring to FIG. 1 again, a method of recycling the chemical solvent used by the dewaxing system 10, namely a method of removing wax out of the mixed solution from the storage device 12, is described as follows.

Firstly, convey the mixed solution with wax from the storage device 12 of the dewaxing system 10 to pass through the cooling equipment 23 of the recycling system 20 for cooling the mixed solution with wax to a preset temperature, solidity or colloid wax is precipitated out of the cooled solution at the preset temperature.

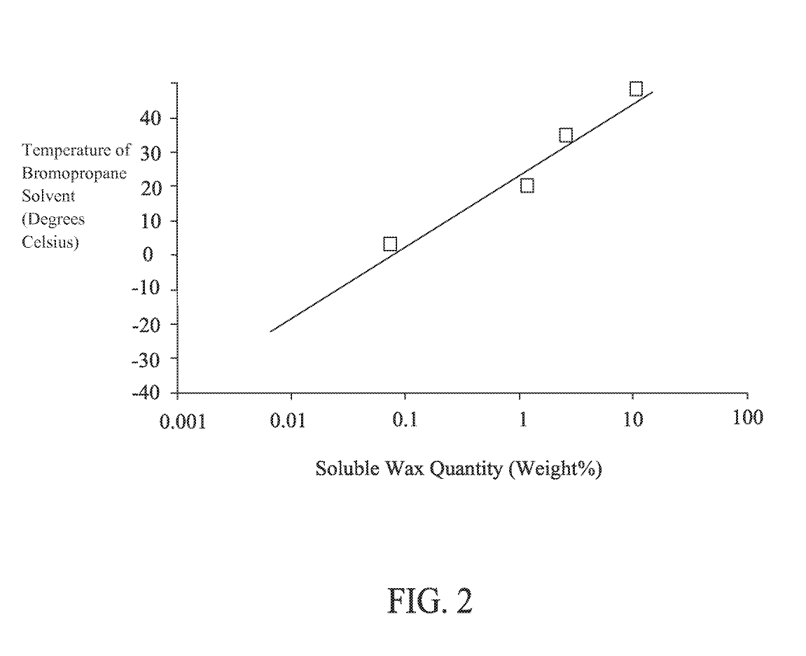

The technical principle of using the cooling equipment 23 to treat the mixed solution with wax is that the soluble wax quantity of the bromopropane solvent does change with temperature. As shown in FIG. 2, the soluble wax quantity of the bromopropane solvent can reach a maximum value of 16% at 45 degrees Celsius, but once back to the room temperature, the soluble wax quantity of the bromopropane solvent will plummet to about 3%; when the temperature of the bromopropane solvent is 0 degrees Celsius, the soluble wax quantity has fallen to 0.1%; if the temperature of the bromopropane solvent continues to be cooled to −30 degrees Celsius, the soluble wax quantity is about 0.01% and the bromopropane solvent is almost pure.

In this invention, the preset temperature can be adjusted on the basis of actual demand. According to the foregoing technical principle, the lower the temperature of the mixed solution is, the less the quantity of wax dissolved in the mixed solution is and the more the quantity of wax precipitated out from the mixed solution is, and finally the purer the recycled bromopropane solvent is. But accordingly, the higher the power consumed by the cooling equipment 23 is. In this embodiment, preferably, the preset temperature is set at −10-0 degrees Celsius.

Then, utilize the filter equipment 22 to filter out the precipitated solidity or colloid wax. In this embodiment, when the preset temperature is set at −10-0 degrees Celsius, the filtered solution passing through the filter equipment 22 is almost pure bromopropane solvent.

Lastly, utilize the recycling trough 21 to contain the filtered solution passing through the filter equipment 22 and further convey the filtered solution back into the storage device 12 of the dewaxing system 10 to be reused.

As described above, according to the technical principle that the soluble wax quantity of the bromopropane solvent does change with temperature, the recycling system 20 of the dewaxing device in this invention utilizes the cooperation design of the cooling equipment 23 and the filter equipment 22 to effectively remove the wax in the mixed solution and finally obtain almost pure bromopropane solvent in the recycling process.

What is claimed is:

1. A dewaxing device of utilizing a chemical solvent to dewax a green part of a product formed by metal injection molding, comprising:
a dewaxing system for dewaxing the green part of the product, the dewaxing system including a rinsing device where the green part of the product is placed and a storage device where the chemical solvent is stored, the storage device being connected with the rinsing device via a circulation pipe for utilizing the chemical solvent to soak and rinse the green part of the product; and
a recycling system including a cooling equipment which is connected with the storage device of the dewaxing system for cooling mixed solution with wax from the storage device to precipitate wax out of the mixed solution, a filter equipment which is connected with the cooling equipment for filtering out the precipitated wax, and a recycling trough which is connected between the filter equipment and the storage device for containing the filtered solution passing through the filter equipment and further conveying the filtered solution back into the storage device to be reused.

2. The dewaxing device as claimed in claim 1, wherein the filter equipment is equipped with a plurality of filters therein.

3. The dewaxing device as claimed in claim 1, wherein the cooling equipment is a refrigerator.

4. A method of recycling a chemical solvent used by a dewaxing device, comprising the steps of:
(1) conveying a mixed solution with wax from a storage device of a dewaxing system of the dewaxing device to pass through a cooling equipment of a recycling system for cooling the mixed solution with wax to a preset temperature, solidity or colloid wax being precipitated out of the cooled solution at the preset temperature;
(2) utilizing a filter equipment to filter out the precipitated solidity or colloid wax; and
(3) utilizing a recycling trough to contain the filtered solution passing through the filter equipment and further convey the filtered solution back into the storage device of the dewaxing system to be reused.

5. The method as claimed in claim 4, wherein in step (1), the preset temperature is adjustable on the basis of actual demand.

6. The method as claimed in claim 5, wherein the preset temperature is set at −10-0 degrees Celsius.
